(19) United States
(12) Patent Application Publication
(10) Pub. No.: US 2017/0249674 A1
(43) Pub. Date: Aug. 31, 2017

(54) USING IMAGE SEGMENTATION TECHNOLOGY TO ENHANCE COMMUNICATION RELATING TO ONLINE COMMERCE EXPERIENCES

(71) Applicant: QUALCOMM Incorporated, San Diego, CA (US)

(72) Inventors: Kameron KERGER, San Diego, CA (US); Joel BERNARTE, San Diego, CA (US)

(21) Appl. No.: 15/055,740

(22) Filed: Feb. 29, 2016

(51) Int. Cl. G06Q 30/02; G06K 9/00; G06T 7/00; G06Q 50/00; G06Q 30/06

(52) U.S. Cl. CPC G06Q 30/0276; G06Q 30/0277; G06Q 50/01; G06Q 30/0643; G06T 7/0081; G06K 9/00677

(57) ABSTRACT

Various aspects and embodiments described herein may use image segmentation technology to enhance communication relating to user-to-user online commerce. Image segmentation technology may be applied to a digital image that a sharing user posts in an online venue to identify one or more segments in the digital image depicting one or more items and one or more tags may be associated with the item(s) depicted in each segment. Accordingly, when an interested user selects a segment in the digital image, information to display to the interested user can be selected (e.g., sorted, filtered, etc.) according to the one or more tags corresponding to the item(s) depicted in the selected segment (e.g., the displayed information may include relevant comments, descriptive information, etc. associated with the depicted item(s). The various aspects and embodiments described herein may thereby focus communication between sharing users and interested users in relation to user-to-user online commerce experiences.

### TECHNICAL FIELD

The various aspects and embodiments described herein relate to using image segmentation technology to enhance communication relating to online commerce.

### BACKGROUND

Websites and other social media outlets that started primarily as social networks have evolved to support user-to-user online commerce in interesting and unexpected ways. For example, many social network users now post pictures that depict items that the users wish to sell, advertise, recommend, review, or otherwise share, and interested users (e.g., potential buyers and/or other users) can then post comments to inquire about the items, negotiate pricing, and even agree on terms to buy things all through the social network. Although this approach may work reasonably well, social media platforms were not originally designed with commerce in mind. As such, while social media platforms and other such sites allow users to interact, some key features that would improve functionality for the use of these social platforms for commerce are lacking.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

According to various aspects, various aspects and embodiments described herein generally relate to using image segmentation technology to enhance communication relating to online commerce experiences, which may include, without limitation, electronic commerce (e-commerce), mobile commerce (m-commerce), user-to-user online commerce, and/or other suitable online commerce experiences. For example, in various embodiments, a first user (e.g., a sharing user) may share a digital image in an online venue, wherein the shared digital image may depict one or more items that are offered for sale, advertised, recommended, reviewed, or otherwise shared. As such, in response to a second user (e.g., an interested user) selecting one or more segments in the shared digital image, information to display to the interested user may be selected (e.g., sorted, filtered, etc.) based on the one or more segments that the interested user selects. More particularly, in various embodiments, image segmentation technology may be used to partition the shared digital image into multiple segments that have certain common characteristics when the sharing user shares the digital image via the online venue. For example, the image segmentation technology may be used to differentiate objects and boundaries in the digital image (e.g., according to lines, curves, etc.). Accordingly, the image segmentation technology may be applied to partition the digital image into multiple segments and one or more objects depicted in the multiple segments may be identified. The sharing user may further indicate one or more of the identified objects corresponding to items to be shared via the online venue along with details associated with the items an optionally an offered sale price with respect to one or more of the items that may be available to purchase. Furthermore, in various embodiments, scene detection technology can be used to automatically identify the objects and suggest the details and the optional sale price to simplify the process for the sharing user. The available items and the corresponding details may then be used to tag the segments in the digital image shared via the online venue and the digital image made visible to other users. Accordingly, the other (interested) users can then select a segment in the digital image and information displayed to the interested users can be selected based on relevant information about the item(s) depicted in the selected segment (e.g., the displayed information may be sorted, filtered, or otherwise selected to increase a focus on the item(s) depicted in the selected segment, which may include pertinent comments about the depicted item(s) that other users have already posted, the details and optional sale price associated with the depicted item(s), etc.). The interested users can then communicate with the sharing user about the specific item(s) in which the interested user has expressed interest (e.g., within the comments section, via a private message, etc.) and optionally complete a transaction to purchase the applicable item(s).

According to various aspects, in response to one or more items depicted in the digital image becoming unavailable (e.g., because the items were sold, are no longer offered for sale, etc.), any segments in the digital image that correspond to the unavailable item(s) may be dimmed or otherwise altered to provide a visual indication that the item(s) are no longer available. As such, the altered digital image may visually indicate any items that have become unavailable and any items that remain available, which may reduce or eliminate unnecessary back-and-forth communication between the sharing user and other users that may potentially be interested in the unavailable items. In various use cases, designating the unavailable items could be automated for both the sharing user and the interested user (e.g., using hashtags such as #sold, an online commerce tie-in such as PayPal, etc.). Furthermore, in various embodiments, information about completed sales may be made visible in the relevant area in the digital image, whereby the information displayed to a potentially interested user who selects a segment depicting one or more unavailable item(s) may be selected to show the relevant sale information in a generally similar manner as described above with respect to sorting, filtering, or otherwise selecting the information displayed to interested users that select one or more segments that depict available items.

According to various aspects, a method for enhanced communication in online commerce may comprise applying image segmentation technology to a digital image shared by a first user in an online venue to identify one or more segments in the digital image that depict one or more shared items, associating the one or more segments identified in the digital image with one or more tags that correspond to the one or more shared items, determining that a second user has selected a segment in the shared digital image that depicts at least one of the shared items, and selecting information to display to the second user according to the one or more tags associated with the selected segment. For example, in various embodiments, the selected information to display to the second user may exclude comments about the digital image that do not pertain to the at least one shared item depicted in the selected segment. Furthermore, in various embodiments, selecting the information to display to the second user may comprise increasing focus on descriptive details that the first user has provided about the at least one shared item depicted in the selected segment and decreasing focus on descriptive details that the first user has provided about one or more objects in the digital image that are not depicted in the selected segment. With respect to the one or more tags, the method may additionally further comprise applying scene detection technology to recognize the one or more shared items depicted in the digital image and automatically populating the one or more tags to include a suggested description and a suggested price associated with the one or more items recognized in the digital image. In various embodiments, a visual appearance associated with at least one of the segments may be altered in response to determining that an item depicted in the at least one segment is unavailable, and in a similar respect, descriptive details associated with an item depicted in at least one of the segments may be altered in response to determining that the item depicted in the at least one segment is unavailable.

According to various aspects, an apparatus for enhanced communication in online commerce may comprise a memory configured to store a digital image that a first user shared in an online venue and one or more processors coupled to the memory and configured to apply image segmentation technology to the digital image to identify one or more segments in the digital image that depict one or more shared items, associate the one or more segments identified in the digital image with one or more tags that correspond to the one or more shared items, determine that a second user has selected a segment in the shared digital image that depicts at least one of the shared items, and select information to display to the second user according to the one or more tags associated with the selected segment.

According to various aspects, an apparatus may comprise means for storing a digital image that a first user has shared in an online venue, means for identifying one or more segments in the digital image that depict one or more shared items, means for associating the one or more segments identified in the digital image with one or more tags that correspond to the one or more shared items, means for determining that a second user has selected a segment in the shared digital image that depicts at least one of the shared items, and means for selecting information to display to the second user according to the one or more tags associated with the selected segment.

According to various aspects, a computer-readable storage medium may have computer-executable instructions recorded thereon, wherein the computer-executable instructions, when executed on at least one processor, may cause the at least one processor to apply image segmentation technology to a digital image that a first user has shared in an online venue to identify one or more segments in the digital image that depict one or more shared items, associate the one or more segments identified in the digital image with one or more tags that correspond to the one or more shared items, determine that a second user has selected a segment in the shared digital image that depicts at least one of the shared items, and select information to display to the second user according to the one or more tags associated with the selected segment.

Other objects and advantages associated with the aspects and embodiments disclosed herein will be apparent to those skilled in the art based on the accompanying drawings and detailed description.

### BRIEF DESCRIPTION OF THE DRAWINGS

A more complete appreciation of the various aspects and embodiments described herein and many attendant advantages thereof will be readily obtained as the same becomes better understood by reference to the following detailed description when considered in connection with the accompanying drawings which are presented solely for illustration and not limitation, and in which:

FIG. 1 illustrates an exemplary system that can use image segmentation technology to enhance communication relating to online commerce experiences, according to various aspects.

FIG. 2 illustrates an exemplary digital image partitioned into multiple segments depicting available items shared via an online venue, according to various aspects.

FIG. 3 illustrates exemplary user interfaces that can use image segmentation technology to enhance communication relating to online commerce experiences, according to various aspects.

FIG. 4 illustrates an exemplary method to use image segmentation technology on a digital image that depicts one or more available items and to share the segmented digital image in an online venue, according to various aspects.

FIG. 5 illustrates an exemplary method that a server can perform to enhance communication relating to online commerce experiences, according to various aspects.

FIG. 6 illustrates an exemplary wireless device that can be used in connection with the various aspects and embodiments described herein.

FIG. 7 illustrates an exemplary personal computing device that can be used in connection with the various aspects and embodiments described herein.

FIG. 8 illustrates an exemplary server that can be used in connection with the various aspects and embodiments described herein.

### DETAILED DESCRIPTION

Various aspects and embodiments are disclosed in the following description and related drawings to show specific examples relating to exemplary aspects and embodiments. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects and/or embodiments may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

As used herein, the terms “image, “digital image,” and/or variants thereof may broadly refer to a still image, an animated image, one or more frames in a video that comprises several images that appear in sequence, several simultaneously displayed images, mixed multimedia that has one or more images contained therein (e.g., audio in combination with a still image or video), and/or any other suitable visual data that would be understood to include an image, a sequence of images, etc.

The disclosure provides methods, apparatus and algorithms for using image segmentation technology to enhance communication relating to online commerce, which may include, without limitation, electronic commerce (e-commerce), mobile commerce (m-commerce), user-to-user commerce, and/or other online commerce experiences. In one example, the methods, apparatus, and algorithms provided herein provide improved functionality for the use of online venues (e.g., social platforms) for online commerce transactions. The methods, apparatus, and algorithms described herein may, for example, provide for storage, access, and selection of information to display to an interested user (e.g., a potential buyer) based on the interested user selecting one or more segments in a digital image that a sharing user has shared in an online venue to depict one or more available items (e.g., items offered for sale).

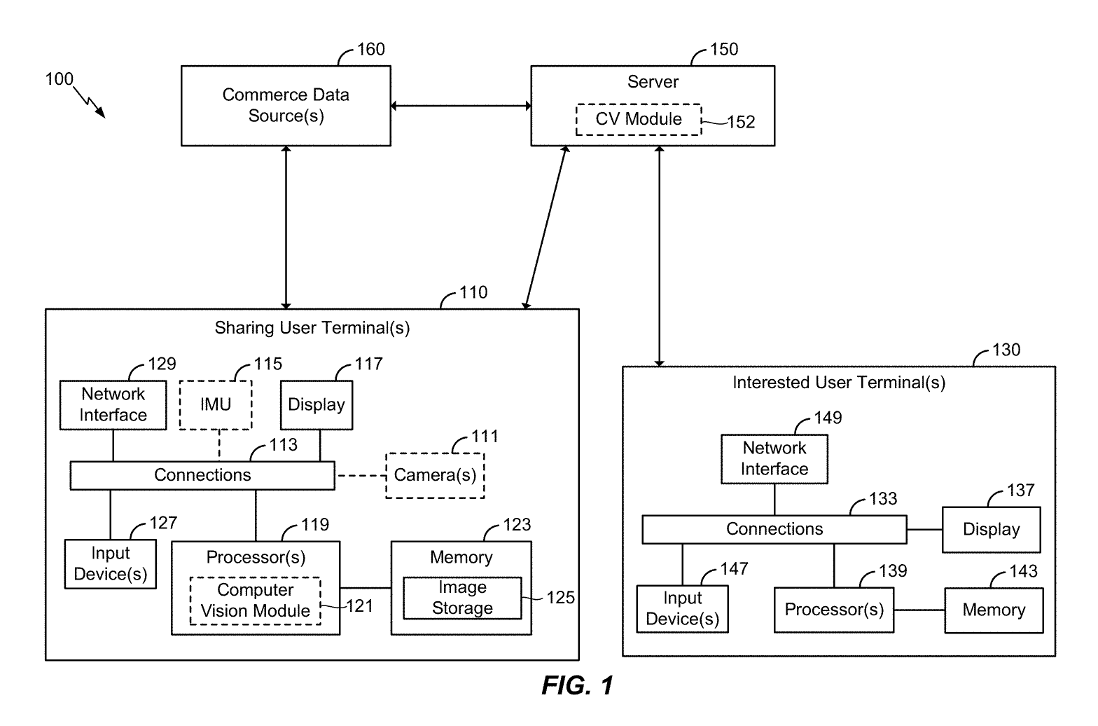

According to various aspects, FIG. 1 illustrates an exemplary system 100 that can use image segmentation technology to enhance communication relating to online commerce experiences. For example, according to various aspects, the system 100 shown in FIG. 1 may use image segmentation technology to select information to be displayed to an interested user (e.g., a potential buyer) based on the interested user selecting one or more segments in a digital image that depicts one or more shared items (e.g., items that are offered for sale, advertised, recommended, reviewed, etc.), wherein the digital image may be shared in an online venue hosted on a server 150 and thereby made visible to the interested user. In particular, when a sharing user shares an image that depicts one or more shared items in the online venue, the image segmentation technology may be used to partition the image into multiple segments that have certain common characteristics. For example, the image segmentation technology may be used to differentiate objects and boundaries in an image (e.g., according to lines, curves, etc.). Accordingly, after the image segmentation technology has been applied to the digital image and one or more objects depicted therein have been suitably identified, the sharing user may indicate one or more objects that are available to purchase, advertised, recommended, shared for review purposes, etc., along with any appropriate details (e.g., an offered sale price). Furthermore, according to various aspects, scene detection technology can be used to automatically identify the objects and suggest the relevant details to make the process simpler to the sharing user. Once the shared items and the corresponding details have been suitably identified, the digital image may be shared in the online venue and made visible to interested users. Accordingly, the interested users can then select a segment in the digital image and information displayed to the interested users can be selected based on the item(s) depicted in the selected segment. For example, in various embodiments, the information displayed to the interested users may be sorted, filtered, or otherwise selected to increase a focus on the relevant information about the item(s) depicted in the selected segment (e.g., pertinent comments about the depicted item(s) that other users have already provided, the details and any offered sale price associated with the depicted items, etc.). The interested users can then communicate with the sharing user about the specific item(s) in which the interested user has interest (e.g., within the comments section, via a private message, etc.) and optionally complete a transaction to purchase the applicable shared item(s).

According to various aspects, in response to one or more items depicted in the digital image becoming unavailable (e.g., because one or more of the depicted items have been sold), any segments in the digital image that correspond to the unavailable item(s) may be dimmed or otherwise altered to provide a visual indication that the item(s) are no longer available. As such, the altered digital image may visually indicate any items that are unavailable and any items that remain available, which may reduce or eliminate unnecessary back-and-forth communication between the sharing user and other users that may be interested in unavailable items. In various use cases, designating the unavailable items could be automated for both the sharing user and the interested user(s) (e.g., using hashtags such as #sold, an online commerce tie-in (e.g., PayPal), an explicit input received from the sharing user indicating that one or more items are unavailable, etc.). Furthermore, information about completed sales and/or other relevant activity may be made available to view in the relevant area in the digital image, whereby the information displayed to an interested user who selects a segment depicting one or more unavailable item(s) may be selected (e.g., sorted, filtered, etc.) to show the relevant information in a generally similar manner as described above with respect to selecting the information displayed to interested users based on depicted items that are available.

With specific reference to FIG. 1, the system 100 shown therein may comprise one or more sharing user terminals 110, one or more interested user terminals 130, the server 150, and one or more commerce data sources 160. For example, according to various aspects, the sharing user terminal(s) 110 and/or the interested user terminal(s) 130 may comprise cellular phones, mobile phones, smartphones, and/or other suitable wireless communication devices. Alternatively, the sharing user terminal(s) 110 and/or the interested user terminal(s) 130 may comprise a personal computer device (e.g., a desktop computer), a laptop computer, a table, a notebook, a handheld computer, a personal navigation device (PND), a personal information manager (PIM), a personal digital assistant (PDA), and/or any other suitable user device. In various embodiments, the sharing user terminal(s) 110 and/or the interested user terminal(s) 130 may have capabilities to receive wireless communication and/or navigation signals, such as by short-range wireless, infrared, wireline connection, or other connections and/or position-related processing. As such, the sharing user terminal(s) 110 and/or the interested user terminal(s) 130 are intended to broadly include all devices, including wireless communication devices, fixed computers, and the like, that can communicate with the server 150, regardless of whether wireless signal reception, assistance data reception, and/or related processing occurs at the sharing user terminal(s) 110, the interested user terminal(s) 130, at the server 150, or at another network device.

Referring to FIG. 1, the sharing user terminal 110 shown therein may include a memory 123 that has image storage 125 to store one or more digital images. Furthermore, in various embodiments, the sharing user terminal 110 may optionally further comprise one or more cameras 111 that can capture the digital images, an inertial measurement unit (IMU) 115 that can assist with processing the digital images, one or more processors 119 (e.g., a graphics processing unit or GPU) that may include a computer vision module 121 to process the digital image, a network interface 129, and/or a display/screen 117, which may be operatively coupled to each other and to other functional units (not shown) on the sharing user terminal 110 through one or more connections 113. For example, the connections 113 may comprise buses, lines, fibers, links, etc., or any suitable combination thereof. In various embodiments, the network interface 129 may include a wired network interface and/or a transceiver having a transmitter configured to transmit one or more signals over one or more wireless communication networks and a receiver configured to receive one or more signals transmitted over the one or more wireless communication networks. In embodiments where the network interface 129 comprises a transceiver, the transceiver may permit communication with wireless networks based on a various technologies such as, but not limited to, femtocells, Wi-Fi networks or Wireless Local Area Networks (WLANs), which may be based on the IEEE 802.11 family of standards, Wireless Personal Area Networks (WPANS) such Bluetooth, Near Field Communication (NFC), networks based on IEEE 802.15x standards, etc., and/or Wireless Wide Area Networks (WWANs) such as LTE, WiMAX, etc. The sharing user terminal 110 may also include one or more ports (not shown) to communicate over wired networks.

In various embodiments, as mentioned above, the sharing user terminal 110 may comprise one or more image sensors such as CCD or CMOS sensors and/or cameras 111, which are hereinafter referred to as “cameras” 111, which may convert an optical image into an electronic or digital image and may send captured images to the processor 119 to be stored in the image storage 125. However, those skilled in the art will appreciate that the digital images contained in the image storage 125 need not have been captured using the cameras 111, as the digital images could have been captured with another device and then loaded into the sharing user terminal 110 via an appropriate input interface (e.g., a USB connection). In implementations where the sharing user terminal 110 includes the cameras 111, the cameras 111 may be color or grayscale cameras, which provide “color information,” while “depth information” may be provided by a depth sensor. The term “color information” as used herein refers to color and/or grayscale information. In general, as used herein, a color image or color information may be viewed as comprising 1 to N channels, where N is some integer dependent on the color space being used to store the image. For example, an RGB image comprises three channels, with one channel each for red, green, and blue information. Furthermore, in various embodiments, depth information may be captured in various ways using one or more depth sensors, which may refer to one or more functional units that may be used to obtain depth information independently and/or in conjunction with the cameras 111. In some embodiments, the depths sensors may be disabled, when not in use. For example, the depth sensors may be placed in a standby mode, or powered off when not being used. In some embodiments, the processors 119 may disable (or enable) depth sensing at one or more points in time. The term “disabling the depth sensor” may also refer to disabling passive sensors such as stereo vision sensors and/or functionality related to the computation of depth images, including hardware, firmware, and/or software associated with such functionality. For example, in various embodiments, when a stereo vision sensor is disabled, images that the cameras 111 capture may be monocular. Furthermore, the term “disabling the depth sensor” may also refer to disabling computation associated with the processing of stereo images captured from passive stereo vision sensors. For example, although stereo images may be captured by a passive stereo vision sensor, the processors 119 may not process the stereo images and may instead select a single image from the stereo pair.

In various embodiments, the depth sensor may be part of the cameras 111. For example, in various embodiments, the sharing user terminal 110 may comprise one or more RGB-D cameras, which may capture per-pixel depth (D) information when the depth sensor is enabled, in addition to color (RGB) images. As another example, in various embodiments, the cameras 111 may take the form of a 3D time-of-flight (3DTOF) camera. In embodiments with 3DTOF cameras 111, the depth sensor may take the form of a strobe light coupled to the 3DTOF camera 111, which may illuminate objects in a scene and reflected light may be captured by a CCD/CMOS sensor in camera 111. The depth information may be obtained by measuring the time that the light pulses take to travel to the objects and back to the sensor. As a further example, the depth sensor may take the form of a light source coupled to cameras 111. In one embodiment, the light source may project a structured or textured light pattern, which may consist of one or more narrow bands of light, onto objects in a scene. Depth information may then be obtained by exploiting geometrical distortions of the projected pattern caused by the surface shape of the object. In one embodiment, depth information may be obtained from stereo sensors such as a combination of an infra-red structured light projector and an infra-red camera registered to a RGB camera. In various embodiments, the cameras 111 may comprise stereoscopic cameras, wherein a depth sensor may form part of a passive stereo vision sensor that may use two or more cameras to obtain depth information for a scene. The pixel coordinates of points common to both cameras in a captured scene may be used along with camera pose information and/or triangulation techniques to obtain per-pixel depth information.

In various embodiments, the sharing user terminal 110 may comprise multiple cameras 111, such as dual front cameras and/or a front and rear-facing cameras, which may also incorporate various sensors. In various embodiments, the cameras 111 may be capable of capturing both still and video images. In various embodiments, cameras 111 may be RGB-D or stereoscopic video cameras that can capture images at thirty frames per second (fps). In one embodiment, images captured by cameras 111 may be in a raw uncompressed format and may be compressed prior to being processed and/or stored in the image storage 125. In various embodiments, image compression may be performed by processors 119 using lossless or lossy compression techniques. In various embodiments, the processors 119 may also receive input from the IMU 115. In other embodiments, the IMU 115 may comprise three-axis accelerometer(s), three-axis gyroscope(s), and/or magnetometer(s). The IMU 115 may provide velocity, orientation, and/or other position related information to the processors 119. In various embodiments, the IMU 115 may output measured information in synchronization with the capture of each image frame by the cameras 111. In various embodiments, the output of the IMU 115 may be used in part by the processors 119 to determine a pose of the camera 111 and/or the sharing user terminal 110. Furthermore, the sharing user terminal 110 may include a screen or display 180 that can render color images, including 3D images. In various embodiments, the display 180 may be used to display live images captured by the camera 111, augmented reality (AR) images, graphical user interfaces (GUIs), program output, etc. In various embodiments, the display 180 may comprise and/or be housed with a touchscreen to permit users to input data via various combination of virtual keyboards, icons, menus, or other GUIs, user gestures and/or input devices such as styli and other writing implements. In various embodiments, the display 180 may be implemented using a liquid crystal display (LCD) display or a light emitting diode (LED) display, such as an organic LED (OLED) display. In other embodiments, the display 180 may be a wearable display, which may be operationally coupled to, but housed separately from, other functional units in the sharing user terminal 110. In various embodiments, the sharing user terminal 110 may comprise ports to permit the display of the 3D reconstructed images through a separate monitor coupled to the sharing user terminal 110.

The pose of camera 111 refers to the position and orientation of the camera 111 relative to a frame of reference. In various embodiments, the camera pose may be determined for six degrees-of-freedom (6DOF), which refers to three translation components (which may be given by x, y, z coordinates of a frame of reference) and three angular components (e.g. roll, pitch and yaw relative to the same frame of reference). In various embodiments, the pose of the camera 111 and/or the sharing user terminal 110 may be determined and/or tracked by the processor 119 using a visual tracking solution based on images captured by camera 111. For example, a computer vision (CV) module 121 running on the processor 119 may implement and execute computer vision based tracking, model-based tracking, and/or Simultaneous Localization and Mapping (SLAM) methods. SLAM refers to a class of techniques where a map of an environment, such as a map of an environment being modeled by the sharing user terminal 110, is created while simultaneously tracking the pose associated with the camera 111 relative to that map. In various embodiments, the methods implemented by the computer vision module 121 may be based on color or grayscale image data captured by the cameras 111 and may be used to generate estimates of 6DOF pose measurements of the camera. In various embodiments, the output of the IMU 115 may be used to estimate, correct, and/or otherwise adjust the estimated pose. Further, in various embodiments, images captured by the cameras 111 may be used to recalibrate or perform bias adjustments for the IMU 115.

As such, according to various aspects, the sharing user terminal 110 may utilize the various data sources mentioned above to analyze the digital images stored in the image storage 125 using the computer vision module 121, which may apply one or more image segmentation technologies and/or scene detection technologies to the digital images that depict items that a user of the sharing user terminal 110 wishes to sell, recommend, advertise, review, or otherwise share in an online venue. For example, the image segmentation technology used at the computer vision module 121 may generally partition a particular digital image that the user of the sharing user terminal 110 has selected to be shared in the online venue into multiple segments (e.g., sets of pixels, which are also sometimes referred to as “super pixels”). As such, the computer vision module 121 may change the digital image into a more meaningful representation that differentiates certain areas within the digital image that correspond to the items to be shared (e.g., based on lines, curves, boundaries, etc. that may differentiate one object from another). In that sense, the image segmentation technology may generally label each pixel in the image with such that pixels with the same label share certain characteristics (e.g., color, intensity, texture, etc.). For example, one known image segmentation technology is based on a thresholding method, where a threshold value is selected to turn a gray-scale image into a binary image. Another image segmentation technology is the K-means algorithm, which is an iterative technique used to partition an image into K clusters. For example, the K-means algorithm initially chooses K cluster centers, either randomly or based on a heuristic, and each pixel in the digital image is then assigned to the cluster that minimizes the distance between the pixel and the cluster center. The cluster centers are then re-computed, which may comprise averaging all pixels assigned to the cluster, and the above-mentioned steps are then repeated until a convergence is obtained (e.g., no pixels change clusters). Accordingly, in various embodiments, the computer vision module 121 may implement one of the above-mentioned image segmentation technologies and/or any other suitable known or future-developed image segmentation technology that can be used to partition the digital image into a more meaningful representation to enable the user of the sharing user terminal 110 to identify the depicted items that are to be shared in the online venue.

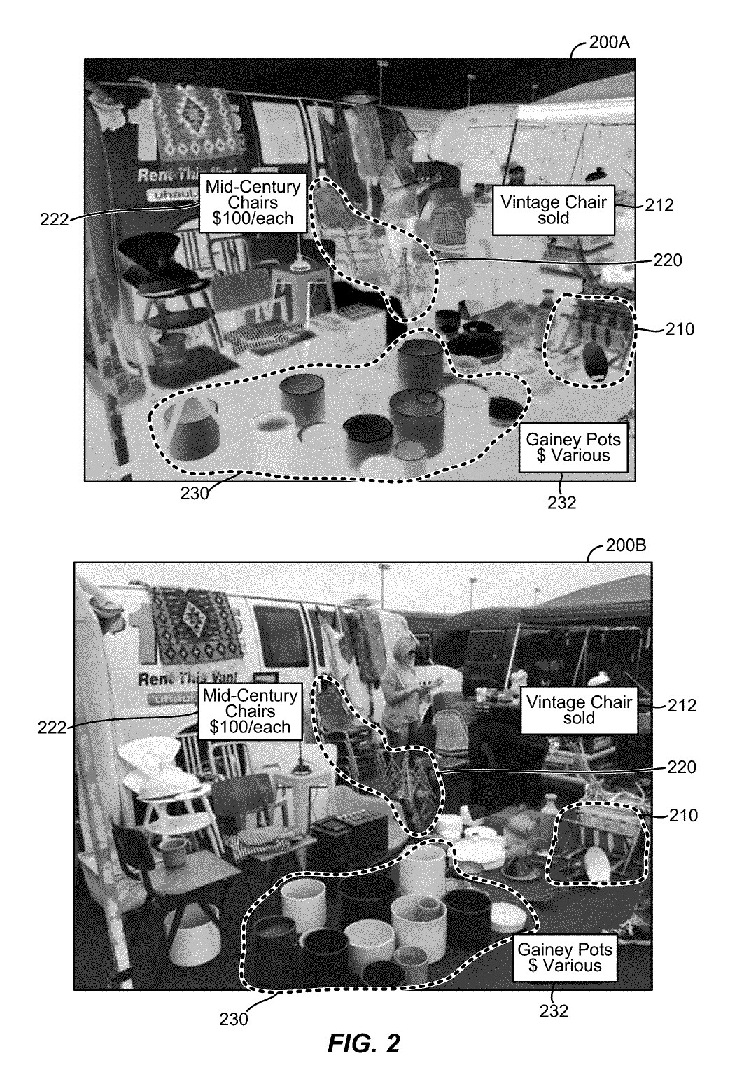

According to various aspects, after the image segmentation technology has been applied to the digital image and the one or more objects depicted therein have been suitably identified, the sharing user may review the segmented image and use one or more input devices 127 (e.g., a pointing device, a keyboard, etc.) to designate one or more objects that correspond to the items to be shared along with any appropriate details (e.g., a description, an offered sale price, etc.). For example, FIG. 2 illustrates an exemplary digital image 200A subjected to an image segmentation process, wherein the digital image 200A includes various segments 210, 220, 230 that depict several items that may be available to purchase, advertised, recommended, reviewed, or otherwise shared via an online venue (e.g., through the sharing user terminal 110 uploading the digital image 200A to the server 150). In particular, as shown in FIG. 2, the digital image 200A includes a first segment 210 that a vintage chair with details shown at 212, a second segment 220 that several mid-century chairs available to purchase at $100/each, as shown at 222, and a third segment 230 that depicts various Gainey pots available to purchase at various different prices, as shown at 232. Furthermore, referring back to FIG. 1, the computer vision module 121 may implement one or more scene detection technologies that can automatically identify the objects depicted in the segments 210, 220, 230 such that the processor 119 can then lookup relevant details associated with the depicted objects (e.g., via the commerce data sources 160), which may substantially simplify the manner in which the sharing user specifies the relevant details. In various embodiments, once the available items to be shared and the corresponding details have been suitably identified, the user of the sharing user terminal 110 may then upload the digital image to the server 150 to be shared in the online venue and made visible to users of the interested user terminals 130. For example, referring again to FIG. 2, the shared digital image may appear as shown at 200B, except that the various dashed lines may not be shown to the interested user terminals 130, as such dashed lines are for illustrative purposes.

According to various aspects, although the foregoing description describes an implementation in which the sharing user terminal 110 includes the computer vision module 121 that applies the image segmentation technology and the scene detection technology to the digital image, in other implementations, the server 150 may include a computer vision module 152 configured to perform the image segmentation technology and the scene detection technology to the digital image. For example, in such implementations, the user of the sharing user terminal 110 may upload the digital image to the server 150 in an unprocessed form, and the server 150 may then use the computer vision module 152 located thereon to perform the functions described above. For example, the computer vision module 152 located on the server 150 may apply the image segmentation technology to the unprocessed digital image uploaded from the sharing user terminal 110 and partition the digital image into multiple segments that differentiate various objects that appear therein. The server 150 may then communicate with the sharing user terminal 110 via the network interface 129 to enable the user of the sharing user terminal 110 to identify the items depicted therein that are to be shared. Furthermore, once the user of the sharing user terminal 110 has reviewed the segmented image and designated the objects in the segmented image that correspond to the items to be shared, the user of the sharing user terminal 110 may further specify the appropriate details (e.g., a description, an offered sale price, etc.). Alternatively (and/or additionally), the computer vision module 152 located on the server 150 may implement one or more scene detection technologies that can automatically identify the items that the user of the sharing user terminal 110 has designated to be shared and retrieve relevant details associated with the depicted objects from the commerce data sources 160, which may be used to populate one or more tags associated with the items (subject to review and possible override by the user of the sharing user terminal 110). As such, whether the image segmentation and/or scene detection technologies are applied using the computer vision module 121 at the sharing user terminal 110 or the computer vision module 152 at the server 150, the segmented digital image may be made available in the online venue for viewing at the interested user terminals 130.

According to various aspects, the interested user terminals 130 may include various components that are generally similar to those on the sharing user terminals 110, including a memory 143, one or more processors 139, a network interface 149 to enable wired and/or wireless communication with the server 150, a display/screen 137 that can be used to view the digital images shared in the online venue, and one or more input devices 147 that can be used to interact with the shared digital images (e.g., to share comments, select certain segments, etc.). The various components on the interested user terminals 130 may also be operatively coupled to each other and to other functional units (not shown) through one or more connections 133, which may comprise buses, lines, fibers, links, etc., or any suitable combination thereof. Furthermore, although FIG. 1 depicts the sharing user terminal 110 as having certain components that are not present on the interested user terminals 130, those skilled in the art will appreciate that such illustration is not intended to be limiting and is instead intended to focus on the relevant aspects and embodiments described herein. Accordingly, in the event that a user of the interested user terminal 130 wishes to share one or more digital images that depict one or more items to be offered for sale, advertised, recommended, or otherwise shared via the online venue and the user of the sharing user terminal 110 wishes to express interest in one or more of such items, those skilled in the art will appreciate that the interested user terminal 130 may include the components used at the sharing user terminal 110 to share such digital images via the online venue (e.g., image storage 125, cameras 111 to capture the digital images, a computer vision module 121 to apply image segmentation technology and/or scene detection technology to the digital images, etc.).

According to various aspects, the user of the interested user terminal 130 can therefore view the digital images that the sharing user terminal(s) 110 shared in the online venue to explore the items that the users of the sharing user terminal(s) 110 are sharing. In particular, the users of the interested user terminals 130 may select a segment in a digital image shared to the online venue using the input devices 147, wherein the users of the interested user terminals 130 may use various mechanisms to select the segment in the digital image. For example, the users of the interested user terminals 130 may click on the segment using a mouse or other pointing device, tap the segment on a touch-screen display, hover the mouse or other pointing device over the segment, and/or provide a gesture-based input (e.g., if the interested user terminal 130 has a camera (not shown) or other image capture device, the gesture-based input may be a hand pose, eye movement that can be detected using gaze-tracking mechanisms, etc.). As such, the various aspects and embodiments described herein contemplate that the users of the interested user terminals 130 may “select” a segment in the digital images using any suitable technique that can dynamically vary from one use case to another (e.g., based on capabilities associated with the interested user terminal(s) 130). In any case, in response to a user at the interested user terminal 130 selecting a particular segment in a digital image that depicts one or more available items shared by a user of the sharing user terminal 110, the server 150 may select information to be displayed at the interested user terminal 130, wherein the selected information may be sorted, filtered, limited, or otherwise identified to increase a focus on relevant information about one or more item(s) depicted in the selected segment (e.g., pertinent comments about the depicted item(s) that other users have already provided, the details associated with the depicted items, etc.). The potential interested users can then communicate with the sharing user about the specific item(s) in which the interested user has expressed interest (e.g., within the comments section, via a private message, etc.) and optionally complete a transaction to purchase the applicable item(s) (e.g., through an online commerce system such as PayPal).

According to various aspects, in response to one or more items depicted in the digital image becoming unavailable (e.g., based on the user of the sharing user terminal 110 completing a sale for one or more of the depicted items), the server 150 may alter any segments in the digital image that correspond to the unavailable item(s) to provide a visual indication that the item(s) are no longer available. For example, in various embodiments, the segments in the digital image that correspond to the unavailable item(s) may be dimmed or otherwise an appearance associated therewith changed to provide a visual cue that the items are no longer available (e.g., as shown in FIG. 2 at 212, where the details show that the vintage chair depicted in segment 210 has been sold). As such, the altered digital image may visually indicate any items that are unavailable and any items that remain available (e.g., in FIG. 2, the descriptive details shown at 222 and 232 indicate that the mid-century chairs depicted in segment 220 are still available and that the Gainey pots depicted in segment 230 are still available). As such, altering the digital image to indicate which items are unavailable and which are still available may eliminate or at least reduce unnecessary communication between the user of the sharing user terminal 110 and other users that may only have interest in items that are no longer available. In various embodiments, designating the unavailable items could be automated for the users at both the sharing user terminal(s) 110 and the interested user terminal(s) 130. For example, the user of the sharing user terminal(s) 110 and/or the user of the interested user terminal(s) 130 may provide a comment that includes a predetermined string that has been designated to indicate when an item has become unavailable (e.g., using a hashtag such as #sold). Alternatively (or additionally), the commerce data sources 160 may store details relating to transactions and/or other suitable activities involving the users at the sharing user terminal(s) 110 and/or the interested user terminal(s) 130. As such, that the server 150 may determine when certain items have been sold or other activities have resulted in certain items becoming unavailable through communicating with the commerce data sources 160. Furthermore, the server 150 may display information about completed sales or other activities that resulted in one or more items becoming unavailable in the relevant area in the digital image (e.g., as shown in FIG. 2 at 212). Accordingly, in various embodiments, the information displayed to a potential interested user who selects a segment depicting one or more unavailable item(s) (e.g., the vintage chair shown in segment 210) may be sorted, filtered, or otherwise selected based on relevant information about the unavailable item(s) in a generally similar manner as described above with respect to interested users that select segments depicting available items.

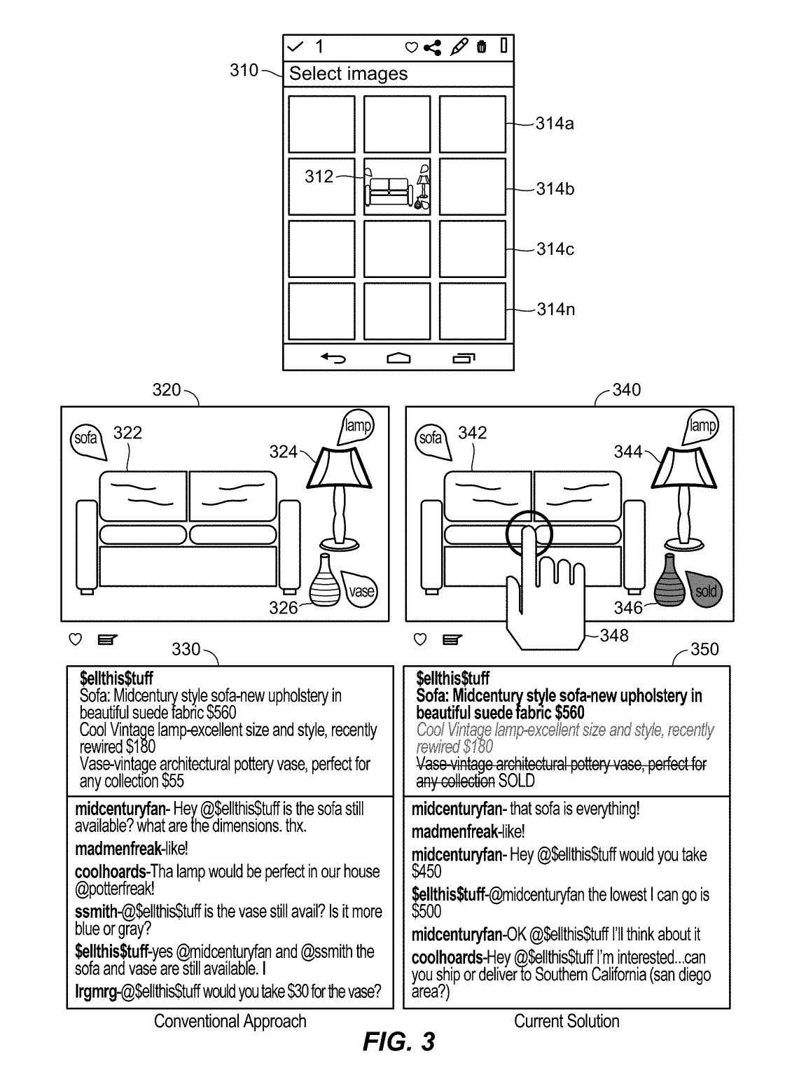

According to various aspects, referring to FIG. 3, various exemplary user interfaces are illustrated to demonstrate the various aspects and embodiments described herein with respect to using image segmentation technology to enhance communication relating to online commerce experiences. For example, FIG. 3 illustrates an example user interface 310 that may be shown on an interested user terminal to show various digital images that depict items that one or more items that one or more sharing users are offering to sell, advertising, recommending, reviewing, or otherwise sharing in an online venue. As shown therein, the user interface 310 includes a first digital image 312 that depicts a sofa, a lamp, and a vase and various other digital images 314a-314n depicting other items. However, in FIG. 3, the other digital images 314a-314n are shown as grayed-out boxes so as to not distract from the relevant details provided herein. As such, those skilled in the art will appreciate that, in actual implementation, the other digital images 314a-314n and the other unlabeled boxes shown in the user interface 310 may also include digital images (or thumbnails) that depict one or more items that one or more users may be sharing in the online venue. Furthermore, in various embodiments, the user interface 310 may be designed such that the images shown therein are all being offered by the same sharing user, match certain search criteria that the interested user may have provided, to allow the interested user to generally browse through digital images depicting offered items, etc.

According to various aspects, FIG. 3 further shows user interfaces 320, 330 that employ a conventional approach to online user-to-user commerce in addition to exemplary user interfaces 340, 350 implementing the various aspects and embodiments described herein. For example, the conventional user interface 320 and the user interface 340 implementing the various aspects and embodiments described herein each depict a sofa 322, 342, a lamp 324, 344, and a vase 326, 346 that a sharing user may be offering to sell or otherwise sharing in the online venue, wherein the sofa 322, 342, the lamp 324, 344, and the vase 326, 346 are shown in the user interfaces 320, 340 based on the interested user selecting the first digital image 312 from the user interface 310. However, assuming that the sharing user has sold the vase 326, 346 (e.g., to another interested user), the user interface 340 differs from the user interface 320 in that the image segment corresponding to the vase 346 has been dimmed and the descriptive label that appears adjacent to the vase 346 has been changed to indicate that the vase 346 is “sold.” Furthermore, the conventional user interface 320 has a comments section 330 that includes descriptive details about each item that was initially shared regardless of whether any items have since been sold or otherwise become unavailable. Further still, the conventional user interface 320 shows each and every comment that the sharing user and any other users have provided about the digital image 312 regardless of whether the comments pertain to the sofa 322, the lamp 324, the vase 326, or general conversation. In contrast, the user interface 340 implementing the various aspects and embodiments described herein includes a focused information area 350, whereby in response to the interested user selecting a particular segment in the digital image 312, the information shown in the focused information area 350 is selected to emphasize information pertinent to the items depicted in the selected segment (e.g., excluding information about other items, sorting the information to display the pertinent information about the items depicted in the selected segment more prominently than information about other items, etc.). For example, as shown in FIG. 3, the interested user has selected the sofa 342, as shown at 348, whereby the comments that appear in the focused information area 350 are selected to include information that pertains to the sofa 342 and to exclude or decrease focus on comments about the lamp 344, the vase 346, and/or any other comments that do not have pertinence to the sofa 342. Furthermore, in the section above the comments (i.e., where the descriptive details that the sharing user has provided are shown), the focused information area 350 includes descriptions associated with the sofa 342, the lamp 344, and the vase 346. However, because the vase 346 has already been sold and is therefore unavailable, the description associated therewith is shown in strikethrough and further indicates that the vase 346 has been “SOLD.” Furthermore, because the interested user selected the sofa 342, the descriptive details about the sofa 342 are displayed in a bold font to draw attention thereto and the descriptive details about the lamp 344 have been changed to a dim font and italicized so as to not draw attention away from the information about the sofa 342. As such, the various aspects and embodiments described herein may substantially enhance communication relating to online commerce experiences through providing more focus and/or detail about items in which interested users have expressed interest. In addition, the various aspects and embodiments described herein may decrease a focus and/or level of detail about items that the interested users are not presently exploring, optionally excluding all details about the items that the interested users are not presently exploring altogether. Furthermore, the various aspects and embodiments described herein may provide visual cues to indicate which items are available and which items are unavailable, and so on.

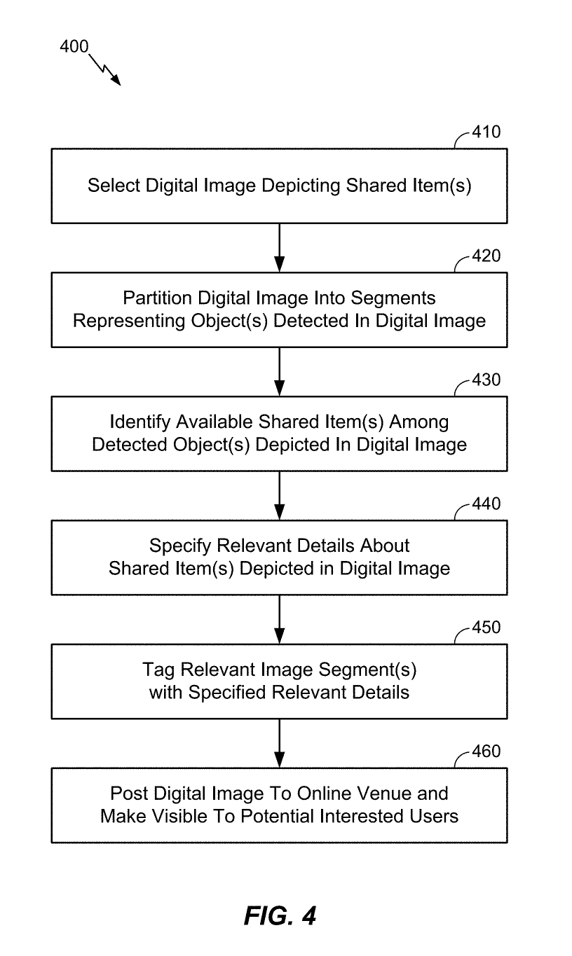

According to various aspects, FIG. 4 illustrates an exemplary method 400 to use image segmentation technology on a digital image that depicts one or more available items and to share the segmented digital image in an online venue. More particularly, at block 410, a sharing user may select a digital image that depicts one or more available items that the selling user wishes to sell, advertise, recommend, review, or otherwise share in the online venue. For example, in various embodiments, the sharing user may select the digital image from a local repository on a sharing user terminal, from one or more digital images that the sharing user has already uploaded to a server, and/or any other suitable source. In various embodiments, at block 420, the digital image may be partitioned into one or more segments that represent one or more objects detected in the digital image. For example, the digital image may be partitioned using a computer vision module located on the sharing user terminal, the server, and/or another suitable device, wherein the computer vision module may apply one or more image segmentation technologies and/or scene detection technologies to the selected digital image. As such, the image segmentation technology may be used at block 420 to partition the digital image into segments that differentiate certain areas within the digital image that may correspond to the available items to be shared (e.g., based on lines, curves, boundaries, etc. that may differentiate one object from another). In that sense, the image segmentation technology may generally label each pixel in the image such that pixels with the same label share certain characteristics (e.g., color, intensity, texture, etc.). In various embodiments, at block 430, the sharing user may then identify the one or more available items to be shared among the one or more objects depicted in the digital image that were detected using the computer vision module.

According to various aspects, at block 440, the sharing user may review the segmented digital image and specify relevant details about the one or more available items to be shared, which may include a description associated with the one or more available items, an optional sale price about one or more of the available items that are to be offered for sale, and/or other suitable relevant information about the one or more available items to be shared in the online venue. For example, in various embodiments, the computer vision module described above may implement one or more scene detection technologies that can automatically identify the objects depicted in the segments such that some or all of the relevant details can be suggested to the sharing user based on information available from one or more online commerce data sources, which may substantially simplify the manner in which the sharing user specifies the relevant details. In various embodiments, at block 450, the one or more image segments may then be associated with one or more tags that relate to the items depicted in each segment, the details relevant to each item, etc. For example, in various embodiments, the one or more tags may be automatically populated with a description and an offered sale price based on the information obtained from the one or more online commerce data sources. However, in various embodiments, the sharing user may be provided with the option to review and/or override the automatically populated tags. In various embodiments, once the sharing user has confirmed the relevant details associated with the depicted item(s) to be shared, the sharing user may then share the digital image in the online venue (e.g., a social media platform) at block 460, whereby the digital image and the one or more items depicted therein may then be made visible to interested users.

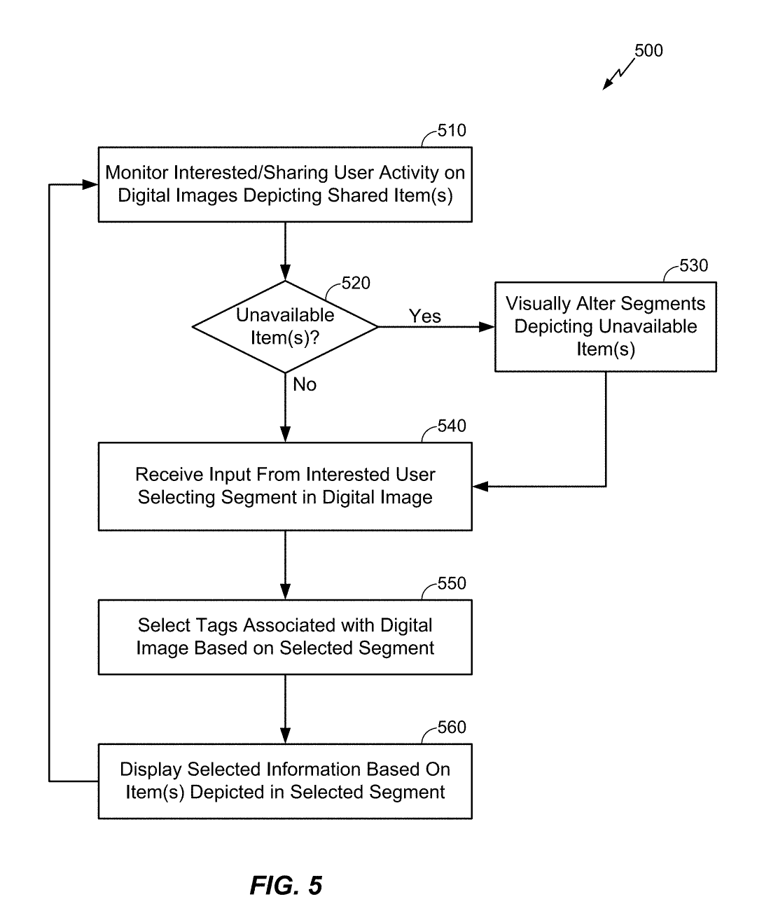

According to various aspects, FIG. 5 illustrates an exemplary method 500 that a network server can perform to enhance communication relating to online commerce experiences. More particularly, based on a sharing user suitably uploading or otherwise sharing a digital image partitioned into segments that depict one or more available items to be shared, at block 510 the server may then monitor activities associated with the sharing user and optionally further monitor activities associated with one or more interested users with respect to the digital images that depict the shared items. For example, in various embodiments, the monitored activities may include any communication involving the sharing user and/or interested users that pertain to the digital image and the shared item(s) depicted therein, public and/or private messages communicated between the sharing user and interested users, information indicating that one or more items depicted in the digital image have been sold or otherwise become unavailable, etc. Accordingly, at block 520, the server may determine whether any item(s) depicted in the digital image are unavailable (e.g., based on the sharing user and/or an interested user providing a comment that includes a predetermined string that has been designated to indicate when an item has been sold, such as #sold, communications that the server facilitates between the sharing user and the interested user through a comments system, a private messaging system, etc., through an internal and/or external online commerce tie-in, etc.).

In various embodiments, in response to determining that any item(s) depicted in the digital image are unavailable, the server may then visually alter any segment(s) in the digital image that depict the unavailable items. For example, in various embodiments, the digital image may be altered to dim any segments that contain unavailable items, to change the descriptive information associated with the unavailable item(s) (e.g., changing text describing the unavailable item(s) to instead read “sold” or the like, to show the description in a strikethrough font, etc.), to remove and/or alter pricing information to indicate that the item is sold or otherwise unavailable, and so on. In various embodiments, at block 540, the server may receive an input selecting a particular segment in the digital image from an interested user, wherein the selected segment may depict one or more of the shared items depicted in the digital image. For example, in various embodiments, the interested user may have the ability to view the digital image that the sharing user shared in the online venue to explore the shared items that are depicted therein, whereby the interested user may provide the input received at block 540 using any suitable selection mechanism(s) (e.g., the interested user may click on the segment using a mouse or other pointing device, tap the segment on a touch-screen display, hover the mouse or other pointing device over the segment, provide a gesture-based input, etc.). As such, at block 550, the server may sort, filter, or otherwise select the information to display to the interested user based on the tags associated with the selected segment in the digital image.

For example, in various embodiments, the server may be configured to select the information to display to the interested user such that the displayed information includes comments about the item(s) depicted in the selected segment and excludes any comments that pertain to general conversation, item(s) that are depicted outside the selected segment, unavailable item(s), etc. Furthermore, in various embodiments, the information displayed to the interested user may be selected to increase a focus on the item(s) depicted in the selected segment and to decrease a focus on any item(s) that are not depicted in the selected segment. For example, a description associated with the item(s) depicted in the selected segment may be associated with a larger, darker, and/or bolder font, while a description associated with any item(s) that are unavailable and/or not depicted in the selected segment may have a smaller, lighter, and/or otherwise less prominent font. In various embodiments, at block 560, the server may then display the selected information based on the information about the item(s) depicted in the selected segment such that the displayed information provides more focus on the item(s) depicted in the selected segment. The method 500 may then return to block 510 such that the server may continue to monitor the sharing user and/or interested user activities relating to the digital image to enhance the communications relating to the shared item(s) depicted therein in a substantially continuous and ongoing manner.

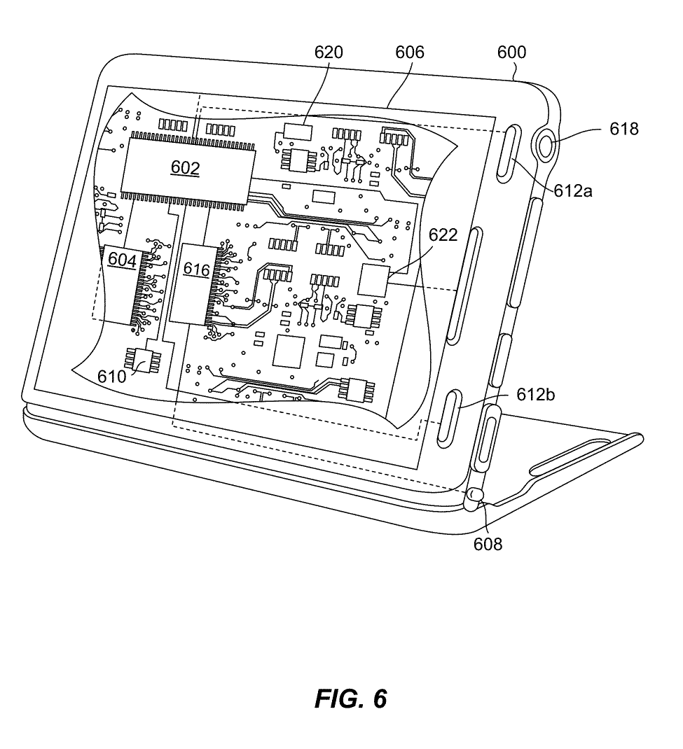

According to various aspects, FIG. 6 illustrates an exemplary wireless device 600 that can be used in connection with the various aspects and embodiments described herein. For example, in various embodiments, the wireless device 600 shown in FIG. 6 may correspond to the sharing user terminal 110 and/or the interested user terminal 130 as shown in FIG. 1. Furthermore, although the wireless device 600 is shown in FIG. 6 as having a tablet configuration, those skilled in the art will appreciate that the wireless device 600 may take other suitable forms (e.g., a smartphone). As shown in FIG. 6, the wireless device 600 may include a processor 602 coupled to internal memories 604 and 610, which may be volatile or non-volatile memories, and may also be secure and/or encrypted memories, unsecure and/or unencrypted memories, and/or any suitable combination thereof. In various embodiments, the processor 602 may also be coupled to a display 606, such as a resistive-sensing touch screen display, a capacitive-sensing infrared sensing touch screen display, or the like. However, those skilled in the art will appreciate that the display of the wireless device 600 need not have touch screen capabilities. Additionally, the wireless device 600 may have one or more antenna 608 that can be used to send and receive electromagnetic radiation that may be connected to a wireless data link and/or a cellular telephone transceiver 616 coupled to the processor 602. The wireless device 600 may also include physical buttons 612a and 612b to receive user inputs and a power button 618 to turn the wireless device 600 on and off. The wireless device 600 may also include a battery 620 coupled to the processor 602 and a position sensor 622 (e.g., a GPS receiver) coupled to the processor 602.

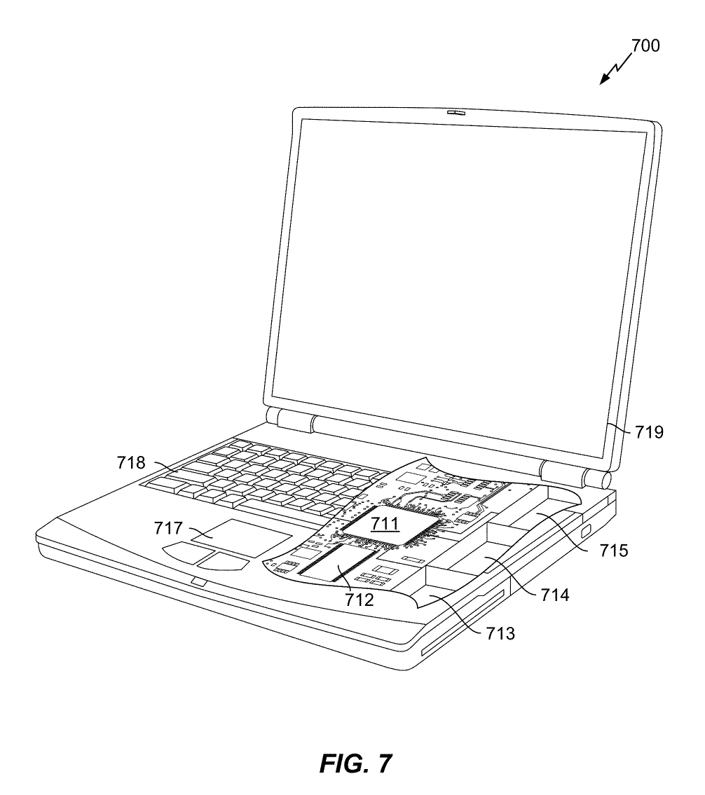

According to various aspects, FIG. 7 illustrates an exemplary personal computing device 700 that can be used in connection with the various aspects and embodiments described herein, whereby the personal computing device 700 shown in FIG. 7 may also and/or alternatively correspond to the sharing user terminal 110 and/or the interested user terminal 130 as shown in FIG. 1. Furthermore, although the personal computing device 700 is shown in FIG. 7 as a laptop computer, those skilled in the art will appreciate that the personal computing device 700 may take other suitable forms (e.g., a desktop computer). According to various embodiments, the personal computing device 700 shown in FIG. 7 may comprise a touch pad touch surface 717 that may serve as a pointing device, and therefore may receive drag, scroll, and flick gestures similar to those implemented on mobile computing devices typically equipped with a touch screen display as described above. The personal computing device 700 may further include a processor 711 coupled to a volatile memory 712 and a large capacity nonvolatile memory, such as a disk drive 713 of Flash memory. The personal computing device 700 may also include a floppy disc drive 714 and a compact disc (CD) drive 715 coupled to the processor 711. The personal computing device 700 may also include various connector ports coupled to the processor 711 to establish data connections or receive external memory devices, such as USB connector sockets, FireWire® connector sockets, and/or any other suitable network connection circuits that can couple the processor 711 to a network. In a notebook configuration, the personal computing device 700 may have a housing that includes the touchpad 717, a keyboard 718, and a display 719 coupled to the processor 711. The personal computing device 700 may also include a battery coupled to the processor 711 and a position sensor (e.g., a GPS receiver) coupled to the processor 711. Additionally, the personal computing device 700 may have one or more antenna that can be used to send and receive electromagnetic radiation that may be connected to a wireless data link and/or a cellular telephone transceiver coupled to the processor 711. Other configurations of the personal computing device 700 may include a computer mouse or trackball coupled to the processor 711 (e.g., via a USB input) as are well known, which may also be used in conjunction with the various aspects and embodiments described herein.

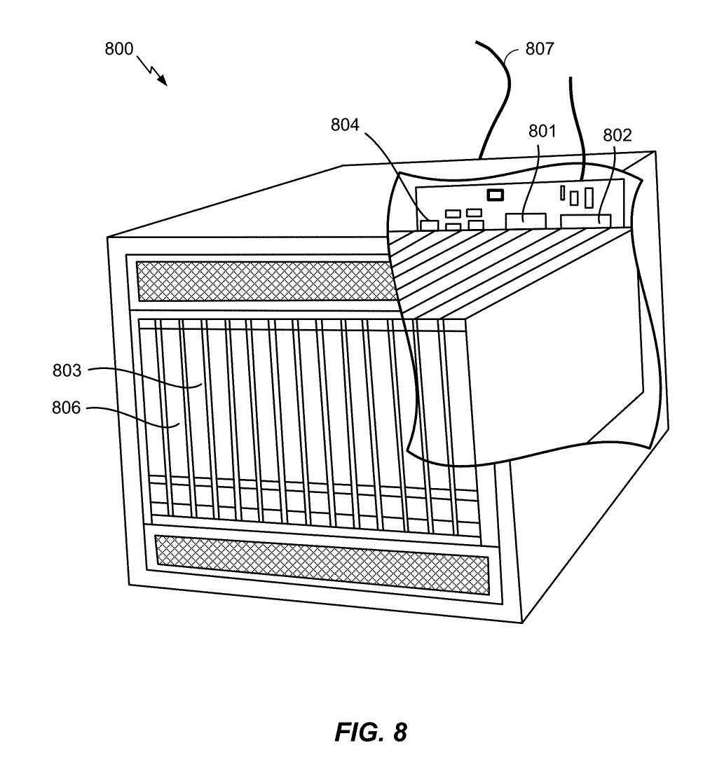

According to various aspects, FIG. 8 illustrates an exemplary server 800 that can be used in connection with the various aspects and embodiments described herein. In various embodiments, the server 800 shown in FIG. 8 may correspond to the server 150 shown in FIG. 1, the commerce data source(s) 160 shown in FIG. 1, and/or any suitable combination thereof. For example, in various embodiments, the server 800 may be a server computer that hosts data with relevant descriptions and prices associated with certain items, a server computer associated with an online commerce service provider that can facilitate user-to-user online transactions, etc.). As such, the server 800 shown in FIG. 8 may comprise any suitable commercially available server device. As shown in FIG. 8, the server 800 may include a processor 801 coupled to volatile memory 802 and a large capacity nonvolatile memory, such as a disk drive 803. The server 800 may also include a floppy disc drive, compact disc (CD) or DVD disc drive 806 coupled to the processor 801. The server 800 may also include network access ports 804 coupled to the processor 801 for establishing data connections with a network 807, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects and embodiments described herein.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an IoT device. In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of a medium. The term disk and disc, which may be used interchangeably herein, includes CD, laser disc, optical disc, DVD, floppy disk, and Blu-ray discs, which usually reproduce data magnetically and/or optically with lasers. Combinations of the above should also be included within the scope of computer-readable media.

While the foregoing disclosure shows illustrative aspects and embodiments, those skilled in the art will appreciate that various changes and modifications could be made herein without departing from the scope of the disclosure as defined by the appended claims. Furthermore, in accordance with the various illustrative aspects and embodiments described herein, those skilled in the art will appreciate that the functions, steps and/or actions in any methods described above and/or recited in any method claims appended hereto need not be performed in any particular order. Further still, to the extent that any elements are described above or recited in the appended claims in a singular form, those skilled in the art will appreciate that singular form(s) contemplate the plural as well unless limitation to the singular form(s) is explicitly stated.

What is claimed is:

1. A method for enhanced communication in online commerce, comprising:
applying image segmentation technology to a digital image shared by a first user in an online venue to identify one or more segments in the digital image that depict one or more shared items;
associating the one or more segments identified in the digital image with one or more tags that correspond to the one or more shared items;
determining that a second user has selected a segment in the shared digital image that depicts at least one of the shared items; and
selecting information to display to the second user according to the one or more tags associated with the selected segment.

2. The method recited in claim 1, wherein the selected information to display to the second user excludes comments about the digital image that do not pertain to the at least one shared item depicted in the selected segment.

3. The method recited in claim 1, wherein selecting the information to display to the second user comprises:
increasing focus on descriptive details that the first user has provided about the at least one shared item depicted in the selected segment; and
decreasing focus on descriptive details that the first user has provided about one or more objects in the digital image that are not depicted in the selected segment.

4. The method recited in claim 1, wherein associating the one or more segments identified in the digital image with the one or more tags comprises:
applying scene detection technology to recognize the one or more shared items depicted in the digital image; and
automatically populating the one or more tags to include a suggested description and a suggested price associated with the one or more shared items recognized in the digital image.

5. The method recited in claim 1, further comprising altering a visual appearance associated with at least one of the segments in response to determining that an item depicted in the at least one segment is unavailable.

6. The method recited in claim 5, wherein the visual appearance associated with the at least one segment is altered to dim the at least one segment.

7. The method recited in claim 1, further comprising altering descriptive details associated with an item depicted in at least one of the segments in response to determining that the item depicted in the at least one segment is unavailable.

8. The method recited in claim 1, further comprising determining that an item depicted in at least one of the segments is unavailable based on one or more of a comment associated with the depicted item including a predetermined string indicating that the depicted item has been sold, information obtained from an electronic commerce system indicating that the first user has sold the depicted item, or an explicit input from the first user indicating that the depicted item is no longer available.

9. The method recited in claim 1, wherein the digital image comprises one or more of a still image, an animated image, a frame in a video, or a mixed multimedia image.

10. The method recited in claim 1, wherein determining that the second user has selected the segment in the shared digital image comprises determining that the segment has been selected via one or more of a pointing device, a touch-screen input, hovering the pointing device over the selected segment, or a gesture-based input.

11. An apparatus for enhanced communication in online commerce, comprising:
a memory configured to store a digital image that a first user shared in an online venue; and
one or more processors coupled to the memory, the one or more processors configured to:
apply image segmentation technology to the shared digital image to identify one or more segments in the digital image that depict one or more shared items;
associate the one or more segments identified in the digital image with one or more tags that correspond to the one or more shared items;
determine that a second user has selected a segment in the shared digital image that depicts at least one of the shared items; and
select information to display to the second user according to the one or more tags associated with the selected segment.

12. The apparatus recited in claim 11, wherein the information to display to the second user is selected to exclude comments about the digital image that do not pertain to the at least one shared item depicted in the selected segment.

13. The apparatus recited in claim 11, wherein the information to display to the second user is selected to increase focus on descriptive details that the first user has provided about the at least one shared item depicted in the selected segment and to decrease focus on descriptive details that the first user has provided about one or more objects in the digital image that are not depicted in the selected segment.

14. The apparatus recited in claim 11, wherein the one or more processors are further configured to:
apply scene detection technology to recognize the one or more shared items depicted; and
automatically populate the one or more tags to include a suggested description and a suggested price associated with the one or more shared items recognized in the digital image.

15. The apparatus recited in claim 11, wherein the one or more processors are further configured to alter a visual appearance associated with at least one of the segments in response to a determination that an item depicted in the at least one segment is unavailable.

16. The apparatus recited in claim 15, wherein the visual appearance associated with the at least one segment is altered to dim the at least one segment.

17. The apparatus recited in claim 11, wherein the one or more processors are further configured to alter descriptive details associated with an item depicted in at least one of the segments in response to a determination that the depicted item is unavailable.

18. The apparatus recited in claim 11, wherein the one or more processors are further configure to determine that an item depicted in at least one of the segments is unavailable based on one or more of a comment associated with the depicted item including a predetermined string indicating that the depicted item has been sold, information obtained from an electronic commerce system indicating that the first user has sold the depicted item, or an explicit input from the first user indicating that the depicted item is no longer available.

19. The apparatus recited in claim 11, wherein the digital image comprises one or more of a still image, an animated image, a frame in a video, or a mixed multimedia image.

20. The apparatus recited in claim 11, wherein the one or more processors are configured to determine that the second user has selected the segment in the shared digital image via one or more of a pointing device, a touch-screen input, hovering the pointing device over the selected segment, or a gesture-based input.

21. An apparatus, comprising:
means for storing a digital image that a first user has shared in an online venue;
means for identifying one or more segments in the digital image that depict one or more shared items;
means for associating the one or more segments identified in the digital image with one or more tags that correspond to the one or more shared items;
means for determining that a second user has selected a segment in the shared digital image that depicts at least one of the shared items; and
means for selecting information to display to the second user according to the one or more tags associated with the selected segment.

22. The apparatus recited in claim 21, wherein the information to display to the second user is selected to exclude comments about the digital image that do not pertain to the at least one shared item depicted in the selected segment.

23. The apparatus recited in claim 21, wherein the information to display to the second user is selected to increase focus on descriptive details that the first user has provided about the at least one shared item depicted in the selected segment and to decrease focus on descriptive details that the first user has provided about one or more objects in the digital image that are not depicted in the selected segment.

24. The apparatus recited in claim 21, further comprising means for altering a visual appearance associated with at least one of the segments depicting an item that is unavailable.

25. The apparatus recited in claim 21, further comprising means for altering descriptive details associated with an item depicted in at least one of the segments that is unavailable.

26. A computer-readable storage medium having computer-executable instructions recorded thereon, wherein executing the computer-executable instructions on at least one processor causes the at least one processor to:
apply image segmentation technology to a digital image that a first user has shared in an online venue to identify one or more segments in the digital image that depict one or more shared items;
associate the one or more segments identified in the digital image with one or more tags that correspond to the one or more shared items;
determine that a second user has selected a segment in the shared digital image that depicts at least one of the shared items; and
select information to display to the second user according to the one or more tags associated with the selected segment.

27. The computer-readable storage medium recited in claim 26, wherein the information to display to the second user is selected to exclude comments about the digital image that do not pertain to the at least one shared item depicted in the selected segment.

28. The computer-readable storage medium recited in claim 26, wherein the information to display to the second user is selected to increase focus on descriptive details that the first user has provided about the at least one shared item depicted in the selected segment and to decrease focus on descriptive details that the first user has provided about one or more objects in the digital image that are not depicted in the selected segment.

29. The computer-readable storage medium recited in claim 26, wherein executing the computer-executable instructions on the at least one processor further causes the at least one processor to alter a visual appearance associated with at least one of the segments depicting an item that is unavailable.

30. The computer-readable storage medium recited in claim 26, wherein executing the computer-executable instructions on the at least one processor further causes the at least one processor to alter descriptive details associated with an item depicted in at least one of the segments that is unavailable.
